(19) United States
(12) Patent Application Publication
(10) Pub. No.: US 2015/0277687 A1
(43) Pub. Date: Oct. 1, 2015

(54) SYSTEM AND METHOD FOR MANIPULATING AND PRESENTING INFORMATION

(71) Applicant: An-Sheng JHANG, Taipei City (TW)

(72) Inventor: An-Sheng JHANG, Taipei City (TW)

(21) Appl. No.: 14/671,604

(22) Filed: Mar. 27, 2015

Related U.S. Application Data
(60) Provisional application No. 61/971,579, filed on Mar. 28, 2014.

(51) Int. Cl. G06F 3/0484; G06F 3/0488; G06F 3/041; G06F 3/0481

(52) U.S. Cl. CPC G06F 3/0484; G06F 3/04817; G06F 3/04883; G06F 3/0412

(57) ABSTRACT

Electronic device configured to display a feed including a plurality of entries based upon selected parameters is provided. The electronic device includes: a touch-sensitive display and a processor. The processor is configured to execute instructions stored on a non-transitory medium. The instructions include: acquiring at least a portion of a feed and the feed being associated with parameters; determining a current feed based on at least one active parameter; presenting the current feed and the at least one active parameter; determining that a request for a modified next feed is requested based on an input received at the electronic device; and generating the modified next feed based on the input from the operator and one or more preferences, which are determined based on operator interaction with the electronic device.

### CROSS-REFERENCE TO RELATED APPLICATION

This application claims benefit of U.S. provisional application Ser. No. 61/971,579 filed Mar. 28, 2014, and entitled “The art of changing automatic aggregated information composition in a computing environment based on human interactions with objects in the composition” which is hereby incorporated herein by reference in its entirety.

### FIELD

The subject matter herein generally relates to controlling the presentation of data feeds. More specifically, the subject matter herein relates to presenting and controlling feeds based on operator instruction.

### BACKGROUND

The Internet contains a plethora of information. Automatic aggregation of information can be traced back to the application of a real simple syndication (RSS), Google News alert, Facebook, Twitter, or Instagram. Information from feeds can be compiled and stored in a database. The operator inputs in one or more search terms and receives information that relates to the search term. The operator can input one or more search terms by typing words into an electronic device. The automatic aggregation system then presents any information in the database that contains the search terms.

### BRIEF DESCRIPTION OF THE DRAWINGS

Implementations of the present technology will now be described, by way of example only, with reference to the attached figures, wherein:

FIG. 1 illustrates a plurality of electronic devices coupled to a feed server in accordance with an exemplary embodiment;

FIG. 2 illustrates an example of an electronic device in accordance with an exemplary embodiment;

FIG. 3 illustrates a first feed including a first entry from a feed database shown on a display of an electronic device in accordance with an exemplary embodiment;

FIG. 4 illustrates a second feed including a first entry from a feed database shown on a display of an electronic device in accordance with an exemplary embodiment;

FIG. 5 illustrates the first entry from the second feed of FIG. 4, where an entry parameter is moved to a parameter bar in accordance with an exemplary embodiment; and

FIG. 6 illustrates the first entry from the first feed of FIG. 3, where an active parameter is moved into an entry attribute bar in accordance with an exemplary embodiment;

FIG. 7 illustrates the first entry from the first feed of FIG. 3, where two parameters are merged in accordance with an exemplary embodiment;

FIG. 8 illustrates a next entry from the first feed of FIG. 3 from a feed database shown on a display of an electronic device in accordance with an exemplary embodiment;

FIG. 9 illustrates a bookmark screen shown on a display of an electronic device in accordance with an exemplary embodiment;

FIG. 10 illustrates a parameter screen shown on a display of an electronic device in accordance with an exemplary embodiment;

FIG. 11 is a flow chart of a method for manipulating and presenting entries from feeds in accordance with an exemplary embodiment; and

FIG. 12 is a flow chart of another method for manipulating and presenting entries from feeds in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term feed means a feed from at least one source which can include RSS, similar to a predefined list with associated attributes. The feed can be a dynamically generated which can include mixed data from different sources, similar to a dynamical generated list with associated attributes. The term ain parts may be exaggs selecting an appropriated predefined list or generating an appropriated list with requirements. The term “interest” means the state of appreciating or wanting to know or learn about something. For example, if the interest is high, the operator has a greater desire to know about it. If the interest is high, the operator could also have appreciated or enjoyed learning about it. A “processor” is a multipurpose, programmable device that accepts digital data as input, processes the data according to instructions stored in its memory, and provides results as output. The term “parameter” means a characteristic, feature, or measurable factor that can help in defining a particular system. A “transitory medium” stores data only for short periods of time and/or only in the presence of power. A “non-transitory medium” stores data for long and enduring periods of time. Non-transitory media expressly exclude media such as energy, carrier signals, electromagnetic waves, and signals per se. For example, non-transitory computer-readable media may include, but is not limited to, RAM, ROM, EEPROM, CD-ROM, or other optical disk storage, magnetic disk storage or other magnetic storage devices, or any other medium which may be used to carry or store desired program code means in the form of computer-executable instructions, data structures, or processor chip design. The term “exemplary embodiment” means one example of one embodiment. An exemplary embodiment is not preferred, nor is it limiting. An exemplary embodiment provides one variation out of a multitude of variations. For example, an exemplary embodiment of a cylinder means one example of a cylinder, but there can be one or more variations of the cylinder. The term “likes” and “like” are defined to be the action or the result of an operator input that indicates an interest in the subject of the “like”. For example, if an operator likes an object, the operator inputs the like, and the number of likes for the object is increased by one. More likes indicate the greater interest the population has for that object. The term “metadata” is defined to be data that describes the contents and context of data files. The term “substantially” is defined to be essentially conforming to the particular direction, such that the direction need not be exact. For example, substantially right means that the direction moves in a rightward way, but can deviate from a true right, as long as the general direction is toward the right. The term “comprising” means “including, but not necessarily limited to”; it specifically indicates open-ended inclusion or membership in a so-described combination, group, series and the like.

The present disclosure provides for an electronic device that is configured to display at least one feed based upon selected parameters. The at least one feed can include a plurality of entries. An entry can include at least one of text, picture, illustration, animation, video, and audio. The entry can include one or more of the above mentioned media or any combination thereof. The electronic device can be a portable communication device, a mobile communication device, a mobile computer, a smartphone, a computing pad, a tablet computer, a personal computer, a desktop computer, a laptop computer, a netbook, a set-top phone, a portable digital assistant (PDA), or other electronic devices capable of at least accepting data, transmitting data, and executing commands. The electronic device can include a touch-sensitive display and a processor coupled to the touch-sensitive display. In at least one embodiment, the touch-sensitive display can include a capacitance-sensitive display, a pressure-sensitive display, or a resistive-sensitive display. In other embodiments, the touch-sensitive display can be any display that is configured to interact with a finger, stylus, pointing device, or other selection “gesture” that is either in contact or near contact with the display.

The processor can be configured to execute instructions stored on a non-transitory medium. The instructions can include acquiring at least a portion of a feed including one or more entries. Each entry can be associated with one or more parameters. The feed can include a current feed and a potential next feed. Each entry in the current feed can also include a set of automatically selected parameters for the potential next feed. The current feed and previous feeds can be linked. The potential next feed can be at least partially dependent on the current feed. The next feed is modified based on changes with the current feed. In at least one embodiment, the feed can include a plurality of entries. Each of the plurality of entries can be of the same types of media, or the plurality of entries can include a mixture of different types of media. In the present disclosure, the bulk of the description focuses on examples involving a plurality of entries, but the present disclosure can be implemented as long as there is at least one entry.

The instructions can also include determining the current feed based on at least one active parameter. The active parameters or initial active parameters can be selected automatically. The automatic selection of parameters can be performed by the feed server based on requested data. In other embodiments, the automatic parameters are selected based on a first entry received from a source. In at least one embodiment, the active parameters can be selected based on popularity from the general public. In other embodiments, the active parameters can be selected based on operator history. For example, the active parameters that the operator most frequently uses can be automatically selected. The active parameters can also be operator defined. In at least one embodiment, the operator can choose from a selection of parameters in a parameter list. In other embodiments, the operator can set one or more active parameters to always be selected. The current feed corresponds to the current active parameters. In at least one embodiment, the current feed always corresponds to the current active parameters. Although the active parameters can be manually changed, the feed may not be changed instantaneously.

The instructions can further include presenting the current feed and the active parameters.

The instructions can also include determining that a request for a modified next feed is requested based on an input received at the electronic device. The request for a modified next feed associated with the modified next feed associated with the current entry can be requested upon receipt of a swipe command or any other command received via the user interface by way of scroll bars, directional arrows, or other indicia that allows for control of movement. In the present application, swiping gestures are presented as examples of gestures, but other gestures can be implemented as well that provide directional movement. In at least one embodiment, the input for a request for a modified next feed can be a swipe right. In other embodiments, the input for a request for a modified next feed can be a swipe left. In yet other embodiments, the input for a request for a modified next feed can be activating a control button, as described below. In yet other embodiments, a modified next feed can be presented automatically after the operator interacts with the parameters. For example, if the operator adds a new active parameter, a modified next feed incorporating the next active parameter can be presented after a predetermined amount of time without further input from the operator.

In at least one embodiment, to swipe right, the operator can drag a finger across the touch-sensitive display toward the right side of the display. In other embodiments, to swipe right, a stylus, pointing device, or other selection “gesture” that is either in contact or near contact with the display can be moved toward the right side of the display. In yet other embodiments, to swipe right, the operator can say a word and the electronic device can process the spoken word and initiate a corresponding action. For example, the operator can say “next” and the electronic device can determine that a request for a modified next feed is requested.

The instructions can further include automatically moving to a next entry in a feed upon lapse of a predetermined amount of time. In at least one embodiment, the instructions can further include automatically moving to a next entry in a feed upon receipt of a vertical scroll command.

The instructions can further include generating the modified next feed based on the input from the user and one or more preferences, which are determined based on user interaction with the electronic device. In at least one embodiment, the instructions can further include creating a more descriptive parameter based upon two or more active parameters. User interaction can include manipulating the active parameters by adding, removing, or merging parameters. The amount of time an operator spends on an entry can also indicate interest in the entry. Likes and comments can also indicate interest in the entry.

In at least one embodiment, the instructions can further include displaying a parameter bar including the at least one active parameter. In at least one embodiment, the active parameters can be ordered in the parameter bar by interest. For example, the active parameter in the first position, which can be closest to the left side of the display, must be included in the next entry. The correspondence with the next feed can diminish as the active parameter is approaching the last position, which can be closest to the right side of the display. In other embodiments, the active parameters can be in the parameter bar in no specific order. At least one entry parameter corresponding to the currently presented entry can be configured to be added to the parameter bar and incorporated as an active parameter. The operator can add the entry parameter to the parameter bar by selecting and dragging the entry parameter to the parameter bar. Once added, the entry parameter becomes a new active parameter and the operator can interact with the new active parameter in the same manner as any active parameter. For example, the operator can move the new active parameter within the parameter bar, merge the new active parameter with at least one other active parameter, or remove the new active parameter from the parameter bar. In at least one embodiment, the operator can remove an active parameter based upon a tree structure thereof or a folder structure thereof. In at least one embodiment, the operator can remove an active parameter based upon a tree structure thereof or a folder structure thereof. For example, if an Egypt parameter is removed, an Africa parameter, being a parent parameter of the Egypt parameter, can be suggested. If a Madonna parameter is removed, a celebrity parameter, being of a same folder structure, can be suggested.

In at least one embodiment, the instructions can further include accessing attributes of the plurality of entries and adjusting a preference of the plurality of entries based on the attributes and current active parameters, wherein the attributes include at least one of likes, comments, time spent, or at least one entry parameter. Attributes can be data that corresponds to and/or describes the entry. Entry parameters are parameters that describe the entry. Entry parameters can be refined as operators suggest entry parameters for the entry. Likes illustrate the amount of interest for the entry. Attributes can also include the number and type of comments. The greater the likes and positive comments the entry receives, the amount of interest in the entry can increase. The greater the negative comments the entry receives, the amount of interest in the entry can decrease. Further, the greater the time spent on the entry can indicate greater amount of interest in the entry.

In at least one embodiment, the operator interaction with the current active parameters can also be recorded. The system can automatically select one combination of parameters among lists of combinations of parameters based on the previous parameters interaction records. For example, based on the record history, the combination of “art” and “Africa” could further increase the amount of interest.

In at least one embodiment, the potential next feed can be based on at least one of the attributes of the plurality of entries, the operator preferences, and the active parameters. The attributes, the operator preferences, and the active parameters are factors that determine which entries in the database should be incorporated in the next feed. For example, the next feed should correspond to the active parameters. Further, as discussed above, attributes can include likes, comments, time spent, and at least one entry parameters. The entry parameters can correspond to the active parameters. Further, the entries can have positive comments and a plurality of likes.

The present disclosure further describes methods for manipulating and presenting at least one feed which includes a plurality of entries. Such a method can include acquiring, at an electronic device, at least a portion of a feed including a plurality of entries and each of the plurality of entries are associated with one or more parameters. The at least one feed can include a current feed and at least one potential next feeds. The current feed can be linked to a previous feed, and the next feed can be linked to the current feed. The potential next feed can be at least partially dependent on the current feed. The potential next feed is modified based on changes with the current feed. The next feed is modified based on changes with the current feed. In at least one embodiment, an entry can include at least one of text, picture, illustration, animation, video, and audio. The entry can include one or more of the above mentioned media or any combination thereof.

The electronic device can be a portable communication device, a mobile communication device, a mobile computer, a smartphone, a computing pad, a tablet computer, a personal computer, a desktop computer, a laptop computer, a netbook, a set-top phone, a portable digital assistant (PDA), or other electronic devices capable of at least accepting data, transmitting data, and executing commands. The electronic device can include a touch-sensitive display and a processor coupled to the touch-sensitive display. In at least one embodiment, the touch-sensitive display can include a capacitance-sensitive display, a pressure-sensitive display, or a resistive-sensitive display. In other embodiments, the touch-sensitive display can be any display that is configured to interact with a finger, stylus, pointing device, or other selection “gesture” that is either in contact or near contact with the display.

The method can also include determining, at the electronic device, the current feed based on at least one active parameter such that the plurality of entries in the current feed correspond to at least one active parameter. The active parameters can be automatically selected. In at least one embodiment, the active parameters can be selected based on popularity from the general public. In other embodiments, the active parameters can be selected based on operator history. For example, the active parameters that the operator most frequently uses can be automatically selected. The active parameters can also be operator defined. In at least one embodiment, the operator can choose from a selection of parameters in a parameter list. In other embodiments, the operator can set one or more active parameters that are always selected.

The method can also include presenting, at the electronic device, the current entry and the at least one active parameter.

The method can also include determining, at the electronic device, that a request for a modified next feed is requested based on an input received at the electronic device. In at least one embodiment, the input can include a swipe right to present the modified next feed and a swipe left to present a previous feed. In other embodiments, a swipe left can be the input to present a modified next feed and a swipe right to present a previous feed. In yet other embodiments, the input for a request for a modified next feed can be activating a control button, as described below. In yet other embodiments, a modified next feed can be presented automatically after the operator interacts with the parameters. For example, if the operator adds a new active parameter, a modified next feed incorporating the next active parameter can be presented after a predetermined amount of time without further input from the operator. In other embodiments, the swiping can be a variety of different directions to achieve various different functions.

In at least one embodiment, to swipe right or left, the operator can drag a finger across the touch-sensitive display toward the respective side of the display. In other embodiments, to swipe right or left, a stylus, pointing device, or other selection “gesture” that is either in contact or near contact with the display can be moved toward the respective side of the display. In yet other embodiments, to swipe right or left, the operator can say a word and the electronic device can process the spoken word and initiate a corresponding action. For example, the operator can say “next” and the electronic device can determine that a request for a modified next feed is requested.

The method can further include automatically moving to a next entry in a feed upon lapse of a predetermined amount of time. In at least one embodiment, the method can further include automatically moving to a next entry in a feed upon receipt of a vertical scroll command.

The method can also include generating, at the electronic device, the modified next feed based on the input from the operator and one or more preferences, which are determined based on operator interaction with the electronic device. In at least one embodiment, the next feed can be based on at least one of the attributes of the entries, the user preferences, and the active parameters.

In at least one embodiment, the method can further include displaying a parameter bar including the at least one active parameter. In at least one embodiment, the active parameters can be ordered in the parameter bar by interest. For example, the active parameter in the first position, which can be closest to the left side of the display, must be included in the next feed. The correspondence with the next feed can diminish as the active parameter is approaching the last position, which can be closest to the right side of the display. In other embodiments, the active parameters can be in the parameter bar in no specific order. At least one entry parameter corresponding to the currently presented entry is configured to be added to the parameter bar and incorporated as an active parameter. In at least one embodiment, an entry author can be added to the parameter bar and incorporated as an active parameter. For example, if the entry author is added to the parameter bar, the modified next feed can include entries corresponding to that entry author. The operator can add the entry parameter to the parameter bar by selecting and dragging the entry parameter to the parameter bar. Once added, the entry parameter becomes a new active parameter and the operator can interact with the new active parameter in the same manner as any active parameter. For example, the operator can move the new active parameter within the parameter bar, merge the new active parameter with at least one other active parameter, or remove the new active parameter from the parameter bar. In at least one embodiment, the operator can remove an active parameter based upon a tree structure thereof or a folder structure thereof. For example, if an Egypt parameter is removed, an Africa parameter, being a parent parameter of the Egypt parameter, can be suggested. If a Madonna parameter is removed, a celebrity parameter, being of a same folder structure, can be suggested.

In at least one embodiment, the method can further include creating a more descriptive parameter, or a merged parameter, based upon two or more active parameters. In at least one embodiment, the operator can create a more descriptive parameter by selecting and dragging at least one active parameter into another at least one active parameter.

In at least one embodiment, the method can further include accessing, at the electronic device, attributes of the plurality of entries, and adjusting, at the electronic device, a preference of the plurality of entries based on the attributes. The attributes can include at least one of likes, comments, time spent, and at least one entry parameter. Attributes can be data that corresponds to and/or describes the entry. Entry parameters are parameters that describe the entry. Entry parameters can be refined as operators suggest entry parameters for the entry. Likes illustrate the amount of interest for the entry. Attributes can also include the number and type of comments. The greater the likes and positive comments the entry receives, the amount of interest in the entry can increase. The greater the negative comments the entry receives, the amount of interest in the entry can decrease. Further, the greater the time spent on the entry can indicate greater interest in the entry.

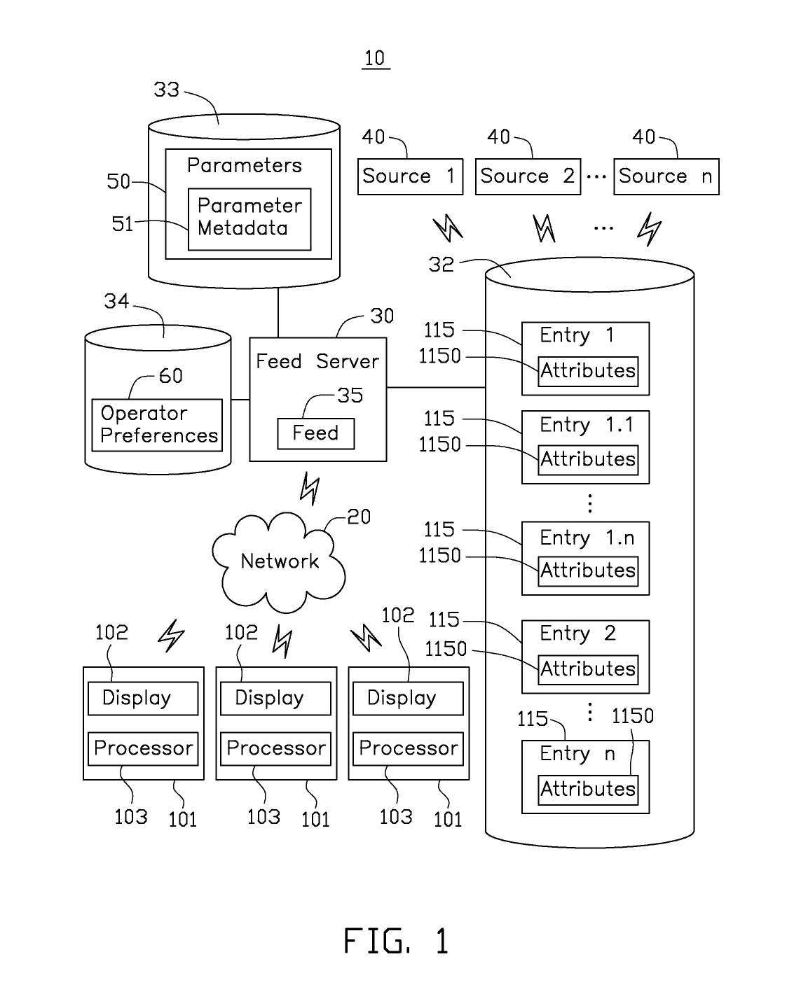

FIG. 1 illustrates an exemplary system 10 for presenting and manipulating information. The system 10 can include one or more devices 101, a network 20, a feed server 30, an entry database 32, a parameter database 33, and an operator database 34. Devices 101 can be coupled to a network 20 which is coupled to a feed server 30. The device 101 can send data such as input from the operator through the network 20 to the feed server 30. The feed server 30 can access data from the entry database 32, the parameter database 33, and operator database 34, and send data to the device 101 through the network 20. The data sent to the device 101 can be at least one feed 35 that includes a plurality of entries 115.

The device 101 can be an electronic device that can receive input from an operator and output information to the operator through an interface. In at least one embodiment, the device 101 can have a processor 103, memory, and a display 102. In at least one embodiment, the display 102 can be a touch-sensitive display. The display 102 can be a capacitance-sensitive display, a pressure-sensitive display, or a resistive-sensitive display. In other embodiments, the touch-sensitive display can be any display that is configured to interact with a finger, stylus, pointing device, or other selection “gesture” that is either in contact or near contact with the display. The device 101 can be a portable communication device, a mobile communication device, a mobile computer, a smartphone, a computing pad, a tablet computer, a personal computer, a desktop computer, a laptop computer, a netbook, a set-top phone, a portable digital assistant (PDA), or other electronic devices capable of at least accepting data, transmitting data, and executing commands. The system 10 can include one or more devices 101. The network 20 can be any means to couple a device 101 to a server. The network 20 can be hardwired, wireless, or a combination thereof. In at least one embodiment, the network 20 can be the Internet. The devices 101 can connect to the network 20 through LAN, WAN, WIFI, short range wireless, or BLUETOOTH.

The feed server 30 can be coupled to an entry database 32, a parameter database 33, and an operator database 34. The entry database 32 can include a plurality of entries from at least one feed 35. The at least one feed 35 can include a plurality of entries 115 that are aggregated from multiple sources 40. For example, entries that contain articles from a news website can be provided by at least one feed while entries that contain pictures from a store website can be provided by another feed. The entry database 32 can include one or more of a photo, text, video, audio, animation, or any information that can be aggregated and presented to the operator.

The parameter database 33 can include parameters 50 that correspond to the entries 115, including at least one of the entry attributes 1150. Parameters 50 can be displayed by an icon. The icon can include at least one of text, image, animation, and any image that can properly convey the meaning of the parameter 50. For example, if the information is a picture of a puppy playing with a child, some exemplary parameters can include dog, puppy, child, and toy. By displaying the parameters 50 as icons, the parameters 50 can be more descriptive than if the parameters 50 were only text. Icons can represent ideas or multiple words within a single parameter 50. Further, as the parameters 50 can be displayed as an icon, the parameters 50 can be manipulated in an intuitive manner. For example, moving and merging icons is more intuitive than merging words. The parameters 50 can include metadata 51 that describes the information and helps organize the information.

The operator database 34 can include data regarding the operator. The operator database 34 can include operator preferences 60. The operator database 34 can include operator information such as the operator profile.

The data from the feed server 30 can be organized based on filters. The filters can be, but are not limited to, at least one of operator preferences 60, parameter metadata 51, entry attributes 1150, date, and time.

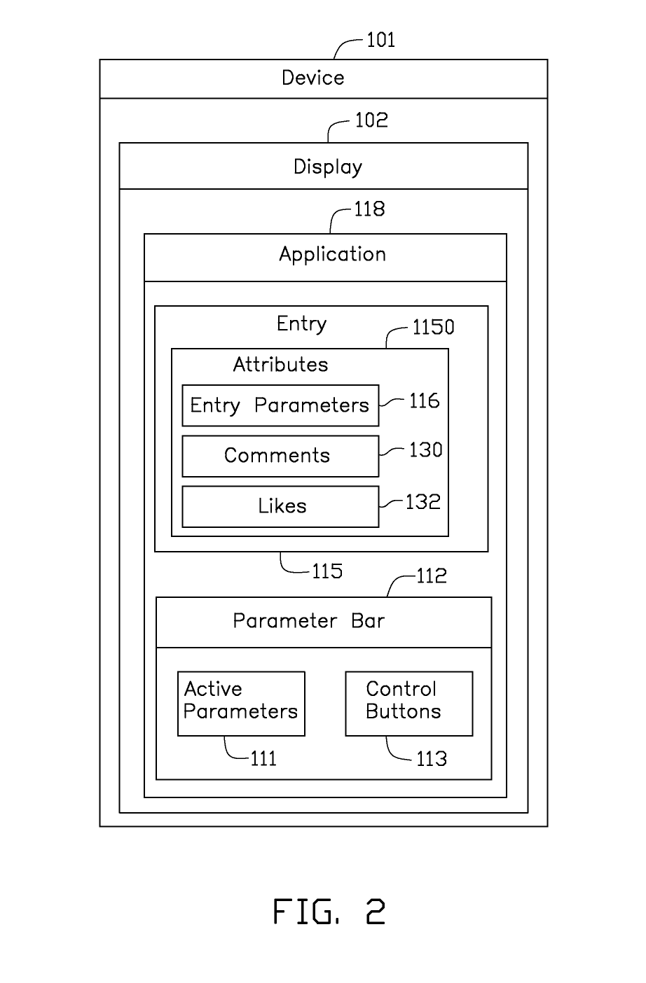

The operator can use a device 101 to interact with the feed server 30 through an application 118 with a graphical user interface (GUI) as illustrated in FIG. 2. The application 118 can be controlled by the processor 103 (as shown in FIG. 1). The application 118 can have an interface that provides data. The data can include, but is not limited to, feeds 35, entries 115, parameters 50, and other data from the feed server 30. Feeds 35 can include a plurality of entries 115. Entries 115 can include information, for example text, image, photo, video, audio, animation, or any information in the entry database 32. Entries 115 can have entry attributes 1150. Entry attributes 1150 can include, but are not limited to, entry parameters 116, likes 132, and comments 131. The application 118 can present the interface through the display 102 of the device 101.

The application 118 can receive input from the operator through the device 101. In at least one embodiment, the input can be by the operator interacting with a display 102, for example a touch-sensitive screen. By interacting with the display 102, the operator can manipulate the information in an intuitive manner. For example, with a touch-sensitive screen, an operator can select a parameter 50 by pressing on the display 102 with a finger. The operator can then drag the finger across the display 102 to move the parameter 50 to any desired location. In other embodiments, the input can be the operator's movements such as a wave of the hand. In yet other embodiments, the input can be from a mouse and keyboard. In yet other embodiments, the input can be controlled by voice or sound.

The application 118, through the processor 103, also learns and updates the operator preferences 60, parameter metadata 51, and entry attributes 1150. The feeds 35 are then reorganized based on the updated operator preferences, parameter metadata 51, and entry attributes 1150.

The application 118 learns the operator preferences through the operator input and interaction with the application 118. For example, when the operator spends a longer length of time on an entry 115, the operator has a greater amount of interest for that type of entry 115. The length of time on an entry 115 can also indicate a greater amount of interest for the active parameters 111. As another example, if the operator likes the information by activating a like button 131 or leaves a positive comment 130, the greater the amount of interest in the entry parameters 116 corresponding to that entry 115. Likes 132 and positive comments 130 for an entry 115 can also indicate a greater amount of interest for the active parameters 111. Subsequently, entries 115 that include or are similar to those entry parameters 116 may be included in the feeds 35 before entries 115 that do not include those entry parameters 116. On the other hand, if the operator leaves a negative comment 130, the lesser the amount of interest in the entry parameters 116 corresponding to that entry 115. Negative comments 130 can also indicate a lower amount of interest in the active parameters 111. Subsequently, entries 115 that include or are similar to those entry parameters 116 may be included in the feeds 35 less than other entries 115.

The application 118 can also account for updates to the parameter metadata 51 and the entry attributes 1150 to provide feeds 35 with entries 115 that would interest the operator. In at least one embodiment, entry attributes 1150 can be the entry parameters 116 that correspond to the entry 115. Entry attributes 1150 can also include the number of likes 132. Entry attributes 1150 can also include the number and type of comments 130. The more likes 132 and positive comments 130 the entry 115 receives, the interest for the entry 115 can increase. The more negative comments 130 the entry 115 receives, the interest for the entry 115 can decrease. Entry parameters 116 can be refined as operators comment on the subject. Entry parameters 116 can also be refined as operators suggest entry parameters 116 for the entry 115.

Parameter metadata 51 can be adjusted based on the operator input regarding the active parameters 111 in the parameter bar 112. Examples of operator input are described in further detail below. The parameter metadata 51 can be adjusted based on the active parameters 111 if the operator performs actions such as activating the like button 131 or comment button 133, as described in further detail below. The parameter metadata 51 can be adjusted based on the entry attributes 1150 if the entry parameters 116 are altered such that the entry parameters 116 are related to more specific information. Examples of adjusting entry parameters 116 are described in further detail below. Further, if the operator regularly chooses a parameter 50 to be an active parameter 111, the amount of interest in that parameter 50 is increased. In at least one embodiment, the parameter metadata 51 can be adjusted and updated based on the cumulative input from the general population of operators. In other embodiments, the parameter metadata 51 can be updated individually based on the input from each operator.

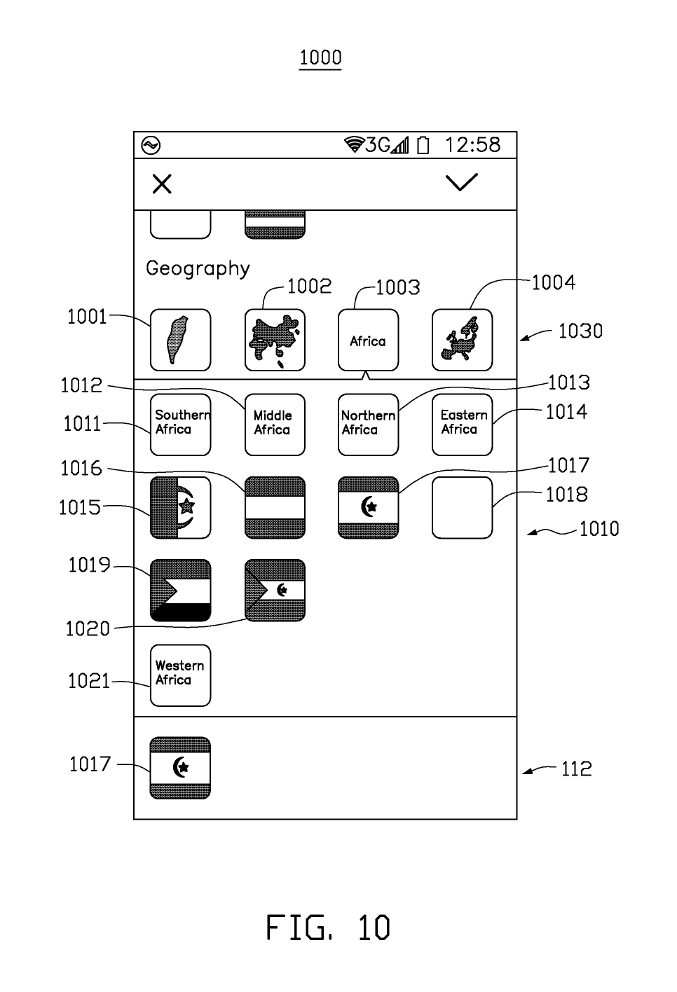

Parameter metadata 51 can include relationships between parameters 50. The parameters 50 can have a tree structure. In a tree structure, parameters can have at least parent parameters 1030 and child parameters 1010. For example, in FIG. 10, an Africa parent parameter 1003 can have child parameters 1010 that include individual countries within Africa. As such, if the operator is interested in the Africa parent parameter 1003, the child parameters 1010 may be suggested. In at least one embodiment, the child parameter 1010 can be Northern Africa 1013. The parameters 50 can also have a folder structure. For example, a Madonna parameter can include a POP parameter and a celebrity parameter. The folder structure can be used when merging or removing parameters 50 from the parameter bar 112. The parameters 50 can also have correlated structure. For example, a winter parameter is correlated to a snow parameter. As such, if the operator is interested in a winter parameter, the snow parameter may be suggested. The correlation between the parameters 50 can be programmed when created. The correlation between the parameters 50 can also be learned. For example, if one parameter is regularly suggested as an entry parameter 116 when another parameter is already an entry parameter 116, those two entry parameters 116 can be determined to be correlated.

The parameter bar 112 can include active parameters 111. The feed 35 to be presented can be based on active parameters 111. The active parameters 111 determine the type of feed 35 to be presented. Active parameters 111 can be manipulated, added, or removed to provide a feed 35 with entries 115 that would interest the operator.

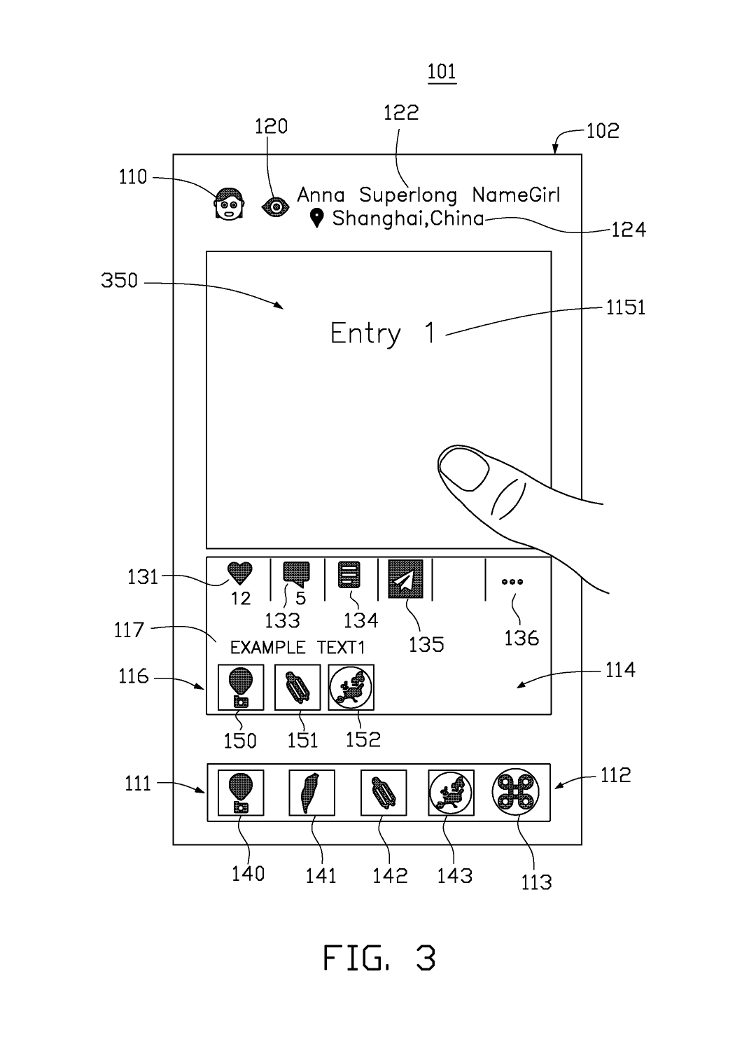

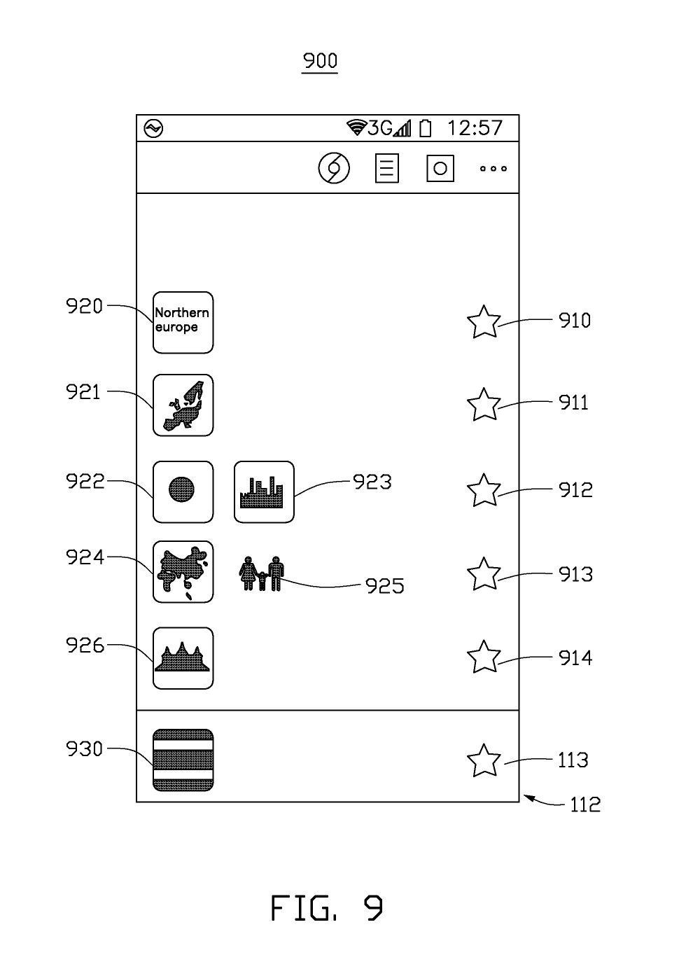

The parameter bar can also include control buttons 113. Control buttons 113 can perform an action. In at least one embodiment, control buttons 113 can direct the application 118 to another screen. In at least one embodiment, a plurality of control buttons 113 can be displayed at the same time in the parameter bar 112. In other embodiments, only one control button 113 is displayed in the parameter bar 112. The control buttons 113 can be displayed as an icon. The icon can include at least one of text, image, animation, and any combination that can symbolize or represent the function of the control button 113. The control button 113 can be changed based on the actions of the operator and state of the application 118. For example, a bookmark button would be displayed to remind the operator to save the feed and access that feed later through the bookmark screen 900 which is described in further detail in FIG. 9. If the active parameters 111 have been changed through operator input to where the entry 115 no longer coincides with the active parameters, a continue button can be displayed. The continue button can remind the operator to use the current set of active parameters 111 to generate a next feed 36 that would better coincide with the active parameters 111. Control buttons 113 can be, but are not limited to, a bookmark button 113 (as shown in FIG. 9) and a continue button 113 (as shown in FIGS. 3-8).

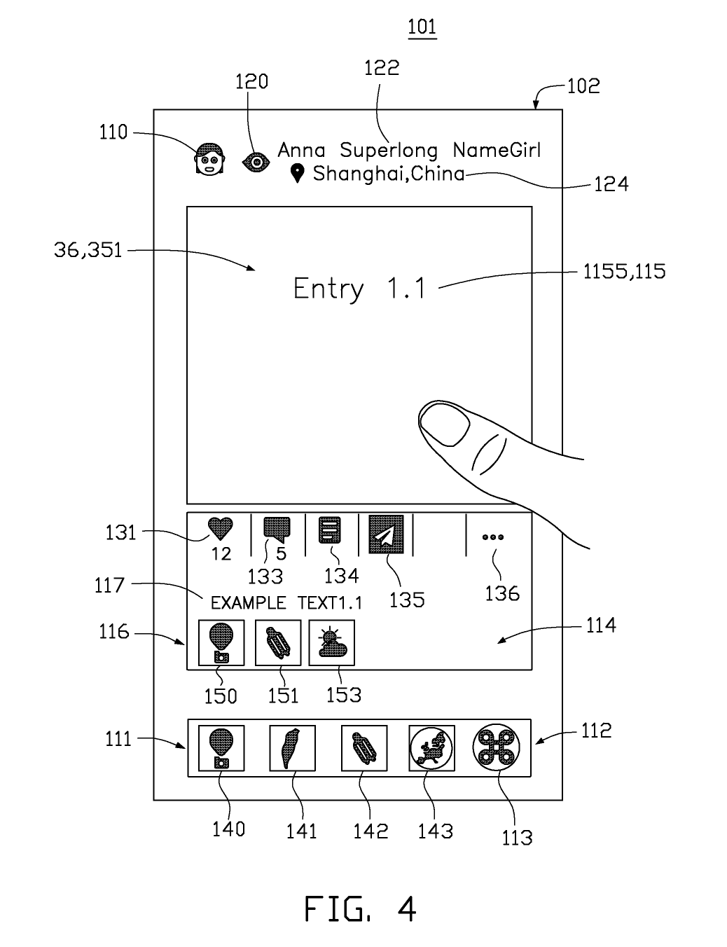

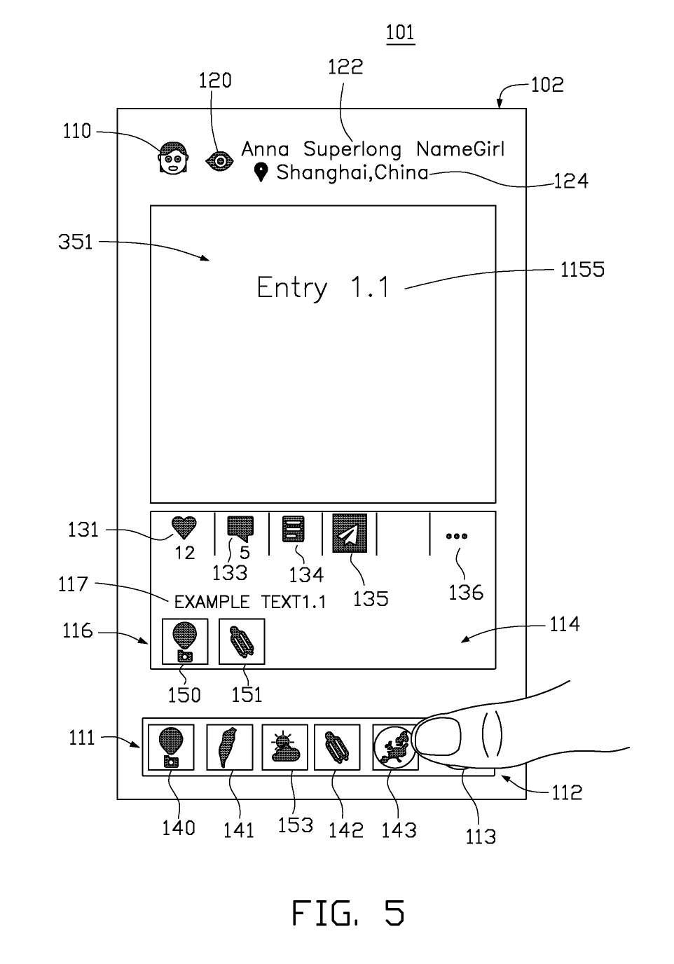

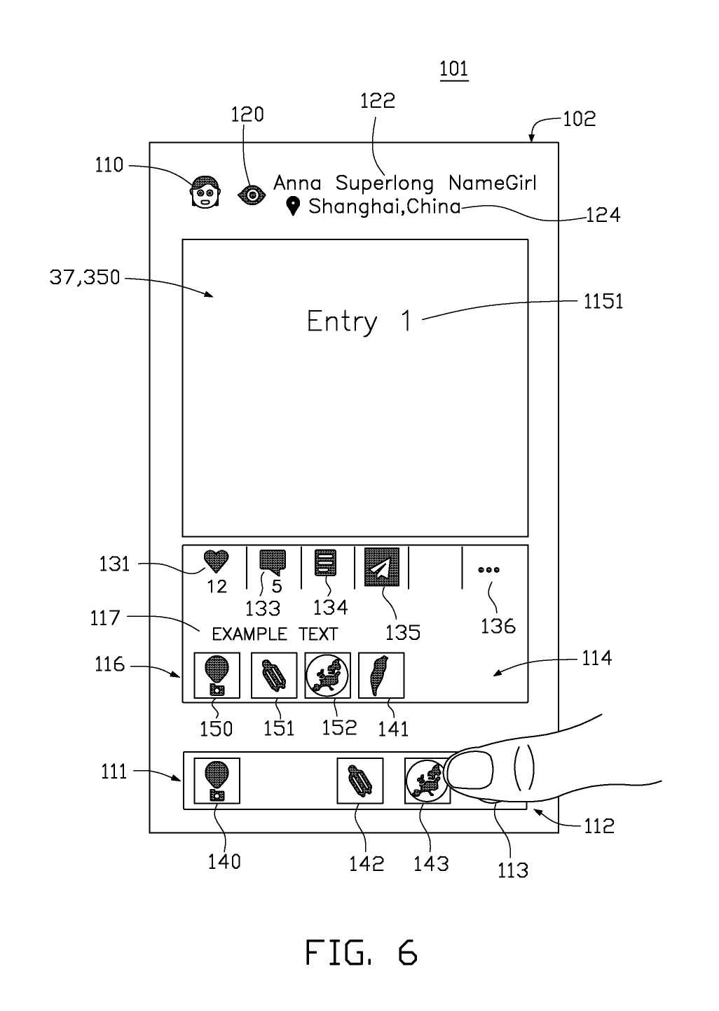

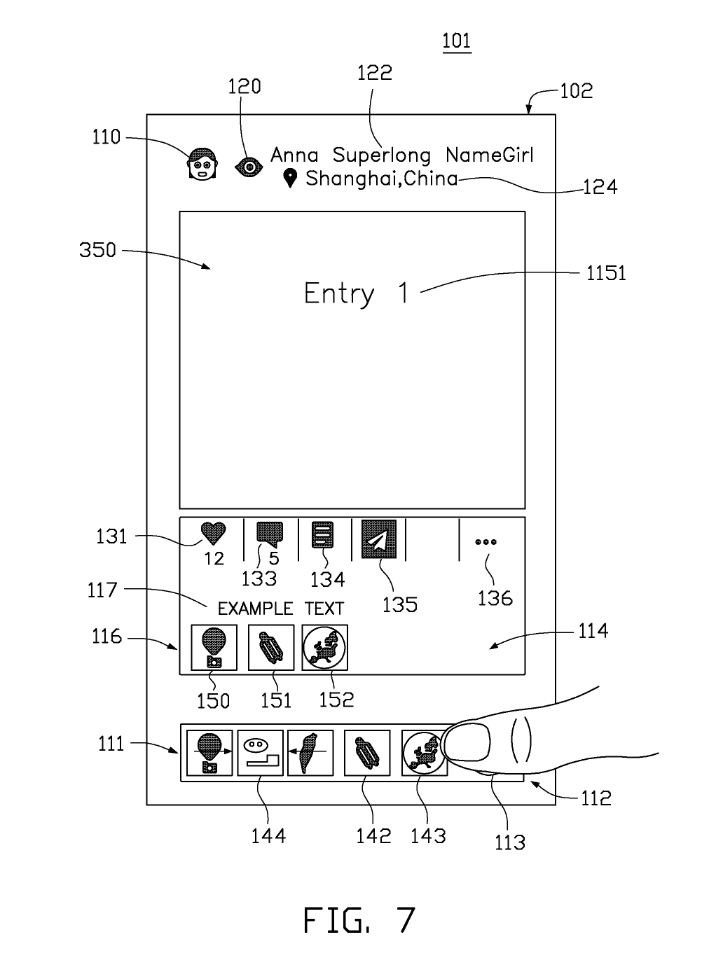

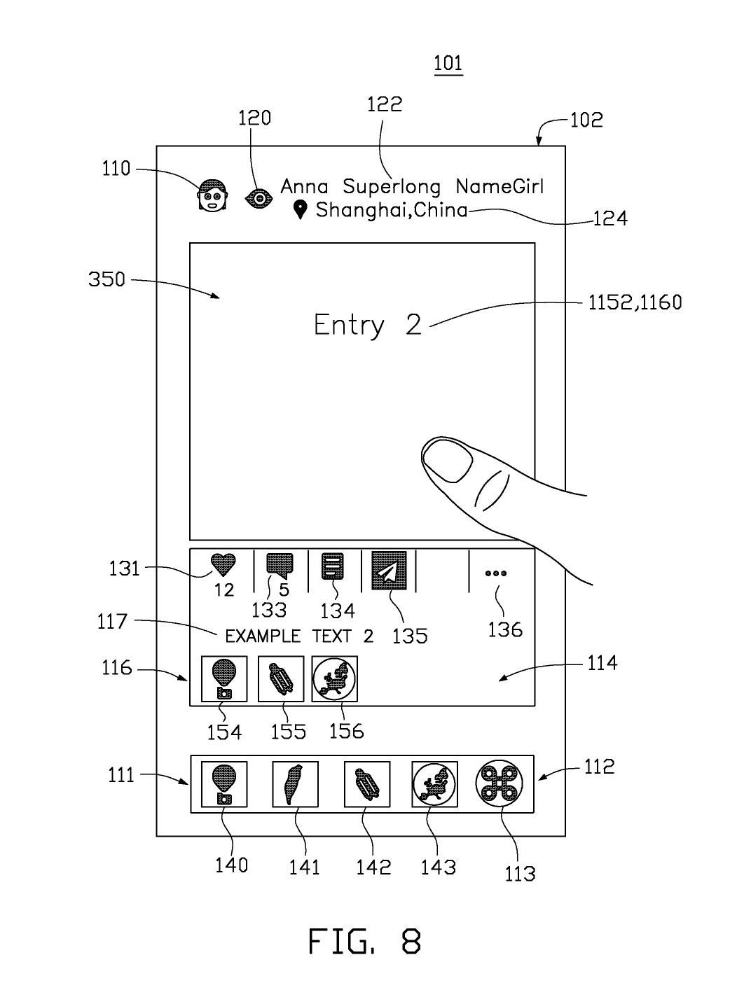

FIGS. 3-8 illustrate the user interacting with the application 118 and manipulating the feeds, the entries, and parameters. FIG. 3 illustrates a first feed 350 with a first entry 1151 shown on a display 102 of an electronic device 101. If the operator swipes right, a second feed 351, or a next feed 36, with a first entry 1155 is presented as illustrated in FIG. 4. Then, the operator can move an entry parameter 116 to the parameter bar 112 to become an active parameter 111 as illustrated in FIG. 5. If the operator swipes left, the previous feed 37 is presented. As such, the first feed 350 from FIG. 3 would be presented. FIG. 6 illustrates the first entry 1151 from the first feed 350 which is also the previous feed 37 from FIG. 5, but where the operator suggested an entry parameter 116 by moving an active parameter 111 to the first entry 1151. FIG. 7 illustrates the first entry 1151 of the first feed 350, but where two active parameters 111 are merged to form a more descriptive parameter 144. If the operator swipes up or down, other entries 115 in the same feed 35 such as the second entry 1152 from the first feed 350 are presented as illustrated in FIG. 8.

FIG. 3 illustrates a first feed 350 with a first entry 1151 shown on a display 102 of an electronic device 101. An entry author 110 can be displayed. The entry author 110 can include a profile icon which can be a picture, a graphic, or text. The entry author 110 can also include a visible icon 120. The entry author 110 can further include the name 122 and location 124 of the entry author 110. In at least one embodiment, the profile icon of the entry author 110 can be a parameter 50 and can be moved into the parameter bar 112 to become an active parameter 111.

Entry attributes 1150 that correspond to the first entry 1151 can be displayed along with the corresponding first entry 1151 on the device 101 through the display 102. In at least one embodiment, the entry attributes 1150 can be displayed below the first entry 1151. In other embodiments, the entry attributes 1150 can be displayed above or to the left or right of the first entry 1151. Entry attributes 1150 can be data that corresponds to and/or describes the first entry 1151. Entry parameters 116 can be refined as operators suggest entry parameters 116 for the entry 1151. Entry attributes 1150 can be, but are not limited to, entry parameters 116, likes 132, comments 130, and information text 117. Entry parameters 116 are parameters 50 that describe the first entry 1151. Likes 132 illustrate the amount of interest in the first entry 1151. Entry attributes 1150 can also include the number and type of comments 130. The greater the likes 132 and positive comments 130 the first entry 115 receives, the amount of interest in the first entry 1151 can increase. The greater the negative comments 130 the first entry 1151 receives, the amount of interest in the first entry 1151 can decrease. In the illustrated embodiment, a like button 131, a comment button 133, information text 117, and entry parameters 116 are displayed. In other embodiments, more or less entry attributes 1150 can be displayed. The entry attributes 1150 can be displayed in different manners to convey the data and allow operator interaction.

If the operator is interested in the first entry 1151, the operator can like the first entry 1151 by activating the like button 131. In at least one embodiment, the like button 131 can be activated by the operator pressing on the display 102 at the location of the like button 131. In other embodiments, the like button 131 can be activated by the operator saying the word “like”. The icon for the like button 131 can then change to indicate that the first entry 1151 is already liked. For example, in the illustrated embodiment, the heart can change colors and the number of likes would increase by 1. The like button 131 can display the number of times operators have liked the first entry 1151.

The operator can also provide input regarding the first entry 1151 by leaving a comment. The operator can leave a comment by selecting the comment button 133. In at least one embodiment, the comment button 133 can be activated by the operator pressing on the display 102 at the location of the comment button 133. A comment box can be displayed, and the operator can input a comment. The comment box can also display the comments that have been inputted for the first entry 1151.

The operator can take notes or share the first entry 1151 by selecting the notes button 134 or share button 135. The first entry 1151 can be shared to any person including the operator. The first entry 1151 can be shared through email, social media, or any other method of sharing information.

The operator can select an options button 136. Through the options button 136, the operator can access further options such as settings, bookmarks, parameter searches, or any other available options.

The entry parameters 116 are also displayed. The entry parameters 116 correspond to the first entry 1151. Similar to active parameters 111, the entry parameters 116 can be displayed as an icon. In the illustrated embodiment, the entry parameters 116 are a picture parameter 150, a suitcase parameter 151, and a world parameter 152.

A parameter bar 112 can include active parameters 111 and control buttons 113. In at least one embodiment, the active parameters 111 can be ordered in the parameter bar 112 by interest. For example, the active parameter 111 in the first position, which can be closest to the left side of the display 102, must be included in the entries 115 in the feed 35. The correspondence with the entries 115 in the feed 35 can diminish as the active parameter 111 is approaching the last position, which can be closest to the right side of the display 102. In other embodiments, the active parameters 111 can be in the parameter bar 112 in no specific order. In the illustrated embodiment, the active parameters 111 are a picture parameter 140, a Taiwan parameter 141, a suitcase parameter 142, and a world parameter 143. The picture parameter 140 can convey photographs and would correspond to entries 115 that include photographs. The Taiwan parameter 141 can convey Taiwan and correspond to entries 115 that include information regarding Taiwan. The suitcase parameter 142 can correspond to entries 115 that relate to traveling. The world parameter 143 can correspond to entries 115 that relate to global interests, for example world news. The first entry 1151 was selected since the first entry 1151 included, along with an operator preference, the picture parameter 150, the suitcase parameter 151, and the world parameter 152 that corresponds to the picture parameter 140, the suitcase parameter 142, and the world parameter 143.

The operator can swipe right to request a next feed 36 as illustrated in FIG. 4. In FIG. 4, the second feed 351 is the next feed 36 of the first feed 350 in FIG. 3. In at least one embodiment, the input for a request for a next feed 36 can be activating a control button 113. In yet other embodiments, a next feed 36 can be presented automatically after the operator interacts with the active parameters 111. For example, if the operator adds a new active parameter 111, a next feed 36 incorporating the new active parameter 111 can be presented after a predetermined amount of time without further input from the operator.

In at least one embodiment, when the operator swipes right, the next feed 36 corresponds to the active parameters 111 in the parameter bar 112. In other embodiments, when the operator swipes right, at least one active parameter 111 is automatically changed. For example, at least one active parameter 111 can be added or removed. The new active parameter 111 can be based on at least the operator preferences 60 and relationships between parameters 50. In other embodiments, the swiping can be a variety of different directions to achieve various different functions.

The operator of an electronic device 101 can swipe by interacting with the application 118 to create an input in any direction, for example up, down, left, or right. Up is toward the top of the display 102, down is toward the bottom of the display 102, left is toward the left side of the display 102 when the display 102 faces the operator, and right is toward the right side of the display 102 when the display 102 faces the operator. In at least one embodiment, the operator can swipe by dragging a finger across a touch screen. In another embodiment, the operator can wave a hand in a direction. If the operator swipes right, a next feed 36, or a second feed 351, is presented. The next feed 36 can be based on the operator preferences 60, parameter metadata 51, and entry attributes 1150. The next feed 36 can also be based on the active parameters 111 in the parameter bar 112. In the illustrated embodiment, the second feed 351 includes a plurality of entries 115 that includes a first entry 1155. The plurality of entries including the first entry 1155 of the second feed 351 have entry parameters 116 that correspond to the active parameters 111 in the parameter bar 112.

The entry parameters 116 for the illustrated first entry 1155 of the second feed 351 are a picture parameter 150, a suitcase parameter 151, and a sunshine parameter 153. These correspond to the illustrated active parameters 111 of a picture parameter 140, a Taiwan parameter 141, a suitcase parameter 142, and a world parameter 143. The second feed 351 including the first entry 1155 is similar to the first feed 350 including the first entry 1151. However, the second feed 351 can include entries 115 that have different entry attributes 1150, for example the inclusion of the sunshine parameter 153. The sunshine parameter 153 can correspond to entries 115 that relate to sunny days or sunny skies. As the operator provides input, the next feed 36 is modified to present a feed 35 that includes entries 115 that interests the operator.

If the operator wants to include an entry parameter 116 as an active parameter 111, the operator can move the entry parameter 116 into the parameter bar 112 as illustrated in FIG. 5. The operator can move an entry parameter 116 into the parameter bar 112 by selecting and dragging the entry parameter 116 or pressing the entry parameter 116 for a predetermined amount of time into the parameter bar 112. Once added, the entry parameter 116 becomes a new active parameter 111 and the operator can interact with the new active parameter 111 in the same manner as any active parameter 111. For example, the operator can move the new active parameter 111 within the parameter bar 112, merge the new active parameter 111 with at least one other active parameter 111, or remove the new active parameter 111 from the parameter bar 112. In FIG. 5, the sunshine parameter 153 is moved into the parameter bar 112 to become an active parameter 111. The next feed 36 is then adjusted based on the new set of active parameters 111 in the parameter bar 112. If the operator swipes right or activates the continue control button, a new feed with entries 115 corresponding to the new active parameters 111 will be presented. If the operator decides to return to the previous feed 37, the operator can swipe left.

To remove an active parameter 111, the operator can move the active parameter 111 away from the parameter bar 112 by selecting and dragging the active parameter 111 or pressing the active parameter 111 for a predetermined amount of time. According to the structure in the parameters 50, the parent parameter 1030 or child parameters 1010 can appear in the parameter bar 112 or above the parameter bar 112 as a suggestion to the operator.

If the operator determines that the entry parameters 116 do not adequately describe the entry 115, the operator can suggest entry parameters 116 by moving parameters into the entry parameter bar 114 as illustrated in FIG. 6. The first entry 1151, as described in FIG. 3, is presented, but the operator wants the first entry 1151 to also correspond to the Taiwan parameter 141. The operator can move the Taiwan parameter 141 to the entry parameter bar 114. The Taiwan parameter 141 then becomes an entry parameter 116. The entry attributes 1150 are then adjusted and refined to include the suggested changes. Also, the entries 115 in the entry database 32 are updated to store the changes.

The operator can further manipulate the data by merging parameters as illustrated in FIG. 7. At least one active parameter 111 can be merged with another at least one active parameter 111 to create a more descriptive parameter 144. In at least one embodiment, at least one active parameter 111 can be merged with another at least one active parameter 111 to create a more descriptive parameter 144 when the active parameters 111 are under the same folder structure. The more descriptive parameter 144 includes the metadata from the at least one merged active parameters 111. The next feed 36 is then adjusted based on the new set of active parameters 111 in the parameter bar 112. In the illustrated embodiment, the picture parameter 140 and the Taiwan parameter 141 are merged. A more descriptive parameter 144 is created. The more descriptive parameter 144 includes the data from both the picture parameter 140 and the Taiwan parameter 141. As such, the feeds 35 that correspond to the more descriptive parameter 144 would need to include both the picture parameter 140 and the Taiwan parameter 141 as entry parameters 116. Since the active parameters 111 are changed, the next feed 36 is modified. If the operator swipes right or activates the continue control button, the modified next feed 36 that correspond to the new active parameters 111 in the parameter bar 112 would be presented.

If the operator swipes down, a next entry 1160 in the same feed 35 would be presented as illustrated in FIG. 8. In FIG. 8, the second entry 1152 is the next entry 1160 in the first feed 350. When swiping up or down, in at least one embodiment, the entries 115 from feed 35 are organized periodically, rather than by preferences and parameters. For example, if the operator swipes right, the next feed 36 is based on the operator input, including at least the active parameters 111. If the operator swipes down, the next entry 1160 is the next entry in the feed 35, regardless of the active parameters 111. In the illustrated embodiment, the entry parameters 116 are a picture parameter 154, a suitcase parameter 155, and a world parameter 156. In other embodiments, the entries 115 presented from swiping up or down can be organized by different feeds, topics, or any organization. In at least one embodiment, the operator can set the organization for entries 115 presented from swiping up or down.

In at least one embodiment, a next entry 1160 in the same feed 35 can be presented automatically. The next entry 1160 can be presented without input from the operator. For example, if the currently presented entry 1159 is a video, when the video is finished playing, a next entry 1160 is presented without any input from the operator. In another example, if the currently presented entry 1159 is a photograph or an image, a next entry 1160 is presented without any input from the operator after a predetermined amount of time. In at least one embodiment, before automatically presenting the next entry 1160, the operator can be notified that a next entry 1160 will be presented and the operator can select not to continue to the next entry 1160. For example, a pause control button can be presented, allowing the operator select not to continue to the next entry 1160.

Referring to FIG. 9, the operator can bookmark parameter combinations, which can include only a single parameter, and view the bookmarked parameters in the bookmark screen 900 by selecting the bookmark control button. The operator can deselect the bookmark status of the parameters by selecting the bookmark icon 910, 911, 912, 913, 914 that correspond to the bookmarked parameters 920, 921, 922, 923, 924, 925, 926. In the illustrated embodiment, the operator bookmarked a Northern Europe parameter 920, an island parameter 921, a Japanese parameter 922, a city parameter 923, a world parameter 924, a family parameter 925, and a castle parameter 926. In at least one embodiment, parameters can be bookmarked as a group so the operator can access and view the same types of entries. In other embodiments, parameters can be bookmarked individually.

Active parameters 111 can be automatically selected based on at least one of operator preferences, entries 115 available in the feeds, location of the operator, and time and date. Active parameters 111 can also be chosen by the operator from a parameter screen 1000 as illustrated in FIG. 10. The parent parameters 1030 in the parameter screen 1000 can be displayed and available for selection by the operator. The parent parameters 1030 can be organized by at least one of topic, common attributes, popularity, and frequency of use. In the illustrated embodiment, the parent parameters 1030 are grouped together by topic. The parent parameters 1030 shown are a Taiwan parameter 1001, a world parameter 1002, an Africa parameter 1003, and an island parameter 1004. The operator can select a parent parameter 1030 to be an active parameter 111 by moving the parent parameter 1030 to the parameter bar 112 or by selecting the parent parameter 1030.

Parent parameters 1030 can also have one or more child parameters 1010. The one or more child parameters 1010 can be parameters that have a narrower scope than the scope of the parent parameters 1030 but still correspond to the subject matter of the parent parameters 1030. In the illustrated example, the Africa parameter 1003 is selected to show the child parameters 1010 of the Africa parameter 1003. The child parameters 1010 that correspond to the Africa parameter 1003 are a Southern Africa parameter 1011, a middle Africa parameter 1012, a Northern Africa parameter 1013, an Eastern Africa parameter 1014, an Algeria parameter 1015, an Egypt parameter 1016, a Libya parameter 1017, a Morocco parameter 1018, a Sudan parameter 1019, a Western Sahara parameter 1020, and a Western Africa parameter 1021. The operator can select a child parameter 1010 to be an active parameter 111 by moving the child parameter 1010 to the parameter bar 112 or by selecting the child parameter 1010. In the illustrated embodiment, the operator selected the Libya parameter 1017, so the Libya parameter 1017 is in the parameter bar 112 as an active parameter 111.

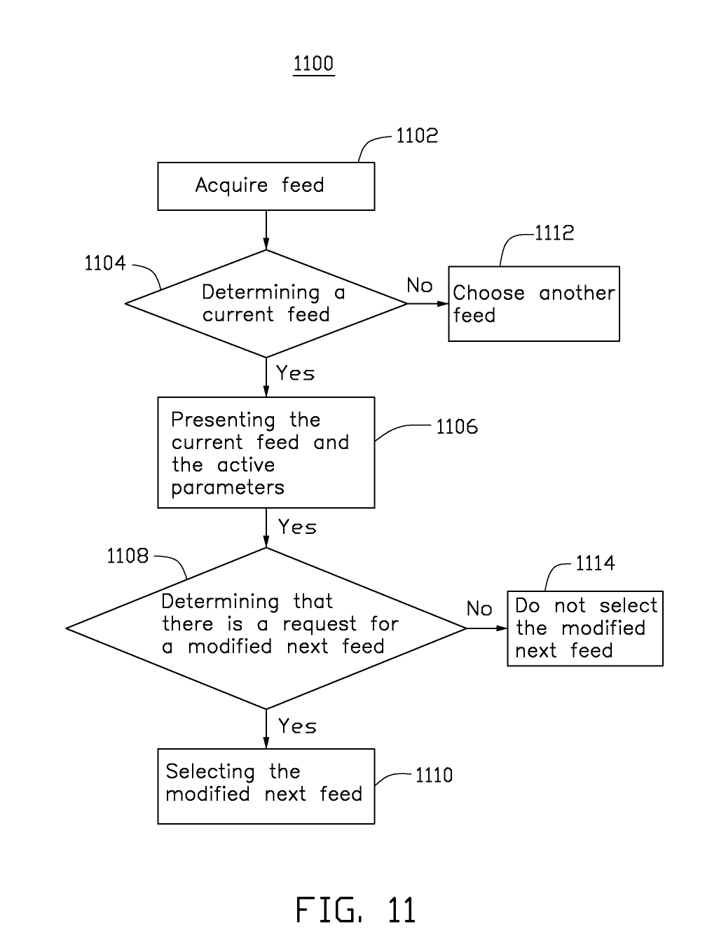

Referring to FIG. 11, a flowchart is presented in accordance with an example embodiment. The method 1100 is provided by way of example, as there are a variety of ways to carry out the method. The method 1100 described below can be carried out using the configurations illustrated in FIGS. 1-10, for example, and various elements of these figures are referenced in explaining example method 1100. Each block shown in FIG. 11 represents one or more processes, methods or subroutines, carried out in the example method 1100. Furthermore, the illustrated order of blocks is illustrative only and the order of the blocks can change according to the present disclosure. Additional blocks may be added or fewer blocks may be utilized, without departing from this disclosure. The example method 1100 can begin at block 1102

At block 1102, an electronic device can acquire at least one feed. The at least one feed can include a plurality of entries. Entries can be any information or data as described above. In at least one embodiment, entries can be information from the Internet such as text, a website or a photograph. Feeds can be acquired from at least one database through to a feed server by accessing a network, for example the Internet. Entries can be associated with one or more entry parameters.

At block 1104, the electronic device determines a current feed to be presented based on active parameters. The active parameters can be selected automatically. The active parameters can also be chosen and manipulated by the operator. At block 1112, if the feed does not correspond to the active parameters, the feed is not presented and another feed is considered for presentation as a current feed. To present the current feed, along with the active parameters, a plurality of factors can be considered. The plurality of factors can be at least one of operator preferences such as operator history, date and time of the entry, and entry popularity. For example, if the operator spends more time on entries with certain entry parameters, entries that correspond to those entry parameters 116 can be included in the feed. Entry popularity can be determined by entry attributes. In at least one embodiment, entry popularity can be determined by active parameters. In other embodiments, entry popularity can be determined by entry attributes and active parameters. Entry attributes can be data that corresponds to and/or describes the entry. Entry attributes can be, but are not limited to, entry parameters, likes, and comments. Entry parameters are parameters that describe the entry. Entry parameters can be refined as operators suggest entry parameters for the entry. Likes illustrate the amount of interest for the entry. Entry attributes can also include the number and type of comments. The more likes and positive comments the entry receives, the interest for the entry can increase. The more negative comments the entry receives, the interest for the entry can decrease.

At block 1106, if the current feed is determined, the current feed is presented. Active parameters are also presented. Active parameters are considered when determining a feed to be presented. Active parameters differ from entry parameters in their function. Entry parameters describe a specific entry while active parameters correspond to the interests of the operator. If the entry parameters correspond closely to the active parameters, the operator interest in the entry may be high. On the other hand, if the entry parameters do not correspond to the active parameters, then the operator interest in the entry may be low. The operator can manipulate, remove, or add active parameters to further correspond to the interests of the operator. As the operator provides input which can include manipulating the active parameters, the next feed is modified to provide a feed with entries that interests the operator.

At block 1108, the electronic device determines whether there is a request for a modified next feed. If there is not a request for a modified next feed, the next feed is not selected at block 1114. The active parameters can still be manipulated. Entry attributes can still be updated. As such, the next feed can be further and continuously modified to correspond to the interests of the operator.

At block 1110, if there is a request for a modified next feed, the modified next feed is selected. In at least one embodiment, a request for a modified next feed can be a swipe right. The modified next feed then is considered a current feed, and the method returns to block 1106.

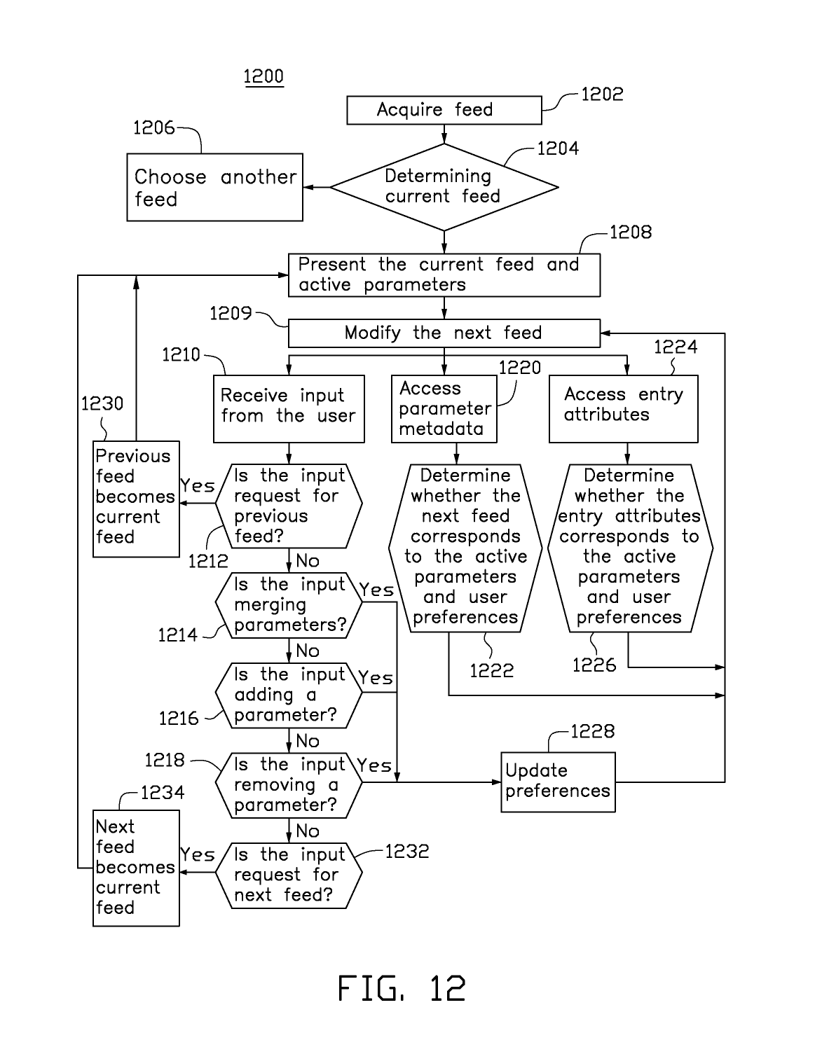

Referring to FIG. 12, a flowchart is presented in accordance with an example embodiment. The method 1200 is provided by way of example, as there are a variety of ways to carry out the method. The method 1200 described below can be carried out using the configurations illustrated in FIG. 12, for example, and various elements of these figures are referenced in explaining example method 1200. Each block shown in FIG. 12 represents one or more processes, methods or subroutines, carried out in the example method 1200. Furthermore, the illustrated order of blocks is illustrative only and the order of the blocks can change according to the present disclosure. Additional blocks may be added or fewer blocks may be utilized, without departing from this disclosure. The example method 1200 can begin at block 1202.

At block 1202, an electronic device can acquire at least one feed. The at least one feed can include a plurality of entries. Entries can be acquired from an entry database coupled to a feed server. Entries can be associated with one or more entry parameters.

At block 1204, the electronic device determines a current feed to be presented based on active parameters. The active parameters can be selected automatically. In at least one embodiment, the active parameters can be selected based on popularity from the general public. In other embodiments, the active parameters can be selected based on operator history. For example, the active parameters that the operator most frequently uses can be automatically selected. The active parameters can also be operator defined. In at least one embodiment, the operator can choose from a selection of parameters in a parameter list. In other embodiments, the operator can set one or more active parameters to always be selected.

At block 1206, if the feed does not correspond to the active parameters, the feed is not presented and another feed is considered for presentation as a current feed. To present the current feed, a plurality of factors can be considered. The plurality of factors can be one or more of active parameters, operator preferences such as operator history, date and time of the entry, and entry popularity. For example, when the operator spends a longer length of time on an entry, the operator has a greater amount of interest for that type of entry. Entry popularity can be determined by entry attributes. Entry attributes can be data that corresponds to and/or describes the entry. Entry attributes can be, but are not limited to, entry parameters, likes, and comments. Entry parameters are parameters that describe the entry. Entry parameters can be refined as operators suggest entry parameters for the entry. Likes illustrate the amount of interest in the entry. Entry attributes can also include the number and type of comments. The greater the likes and positive comments the entry receives, the amount of interest in the entry can increase. The greater the negative comments the entry receives, the amount of interest in the entry can decrease.

At block 1208, at least one of the current feed, corresponding entry parameters, and active parameters are presented. Active parameters are considered when determining a feed to be presented. Active parameters differ from entry parameters in their function. Entry parameters describe a specific entry while active parameters correspond to the interests of the operator. If the entry parameters correspond closely to the active parameters, the operator interest in the entry may be high. On the other hand, if the entry parameters do not correspond to the active parameters, then the operator interest in the entry may be low. The operator can manipulate, remove, or add active parameters to further correspond to the interests of the operator. As the operator provides input which can include manipulating the active parameters, the next feed is modified to provide a feed that interests the operator.

At block 1210, the next feed is modified based on operator input, parameter metadata, and entry attributes as described in further detail below.

At block 1210, input from the operator is received through the electronic device. In at least one embodiment, the input can be by the operator interacting with a display, for example a touch-sensitive screen. In other embodiments, the input can be the operator's movements such as a wave of the hand. In yet other embodiments, the input can be from a mouse and keyboard. In yet other embodiments, the input can be controlled by voice or sound.

At block 1212, the electronic device determines if the input is a request for a previous feed. In at least one embodiment, the input for a request for a previous feed can be a swipe left. In other embodiments, the input for a request for a previous feed can be a wave of a hand towards the left. At block 1230, if the input is a request for a previous feed, a stored previous feed becomes the current feed, and the current feed is presented at block 1208. If the input is not a request for a previous feed, the method continues to block 1214.

At block 1214, the electronic device determines if the input is merging parameters. At least two parameters can be merged to create a more descriptive parameter. The more descriptive parameter can represent subject matter from the at least two parameters. At block 1228, if the input is merging parameters, the operator preferences are updated to include the more descriptive parameter, and the method continues to block 1210 to modify the next feed based on the updated preferences.

At block 1216, the electronic device determines if the input is adding a parameter to the parameter bar. At block 1228, if a parameter is added to the parameter bar, the preferences are updated to include the added parameter, and the method continues to block 1210 to modify the next feed based on the updated preferences.

At block 1218, the electronic device determines if the input is removing a parameter from the parameter bar. At block 1228, if a parameter is removed from the parameter bar, the preferences are updated to exclude the removed parameter, and the method continues to block 1210 to modify the next feed based on the updated preferences. As such, the removed parameter is not considered when choosing a next feed.

At block 1220, the electronic device can access parameter metadata. Parameter metadata can adjust based on at least one of the preference of the parameter, the frequency of use of the parameter, and the entries that correspond to the parameter.

At block 1222, the electronic device determines whether the next feed corresponds to the active parameters and operator preferences. If the next feed does not correspond to the active parameters and operator preferences, the next feed can be modified. If the next feed does correspond to the active parameters and operator preferences, the next feed can be modified, or the next feed can remain the same.

At block 1224 the electronic device can access entry attributes for the next entry. Entry attributes can be the entry parameters that correspond to the entry, the number of likes the entry has received, and the comments that the entry has received.

At block 1226, the electronic device determines whether the entry attributes correspond to the active parameters and operator preferences. If the entry attributes do not correspond to the active parameters and operator preferences, the next feed can be modified. If the entry attributes do correspond to the active parameters and operator preferences, the next feed can be modified, or the next feed can remain the same.

At block 1232, the electronic device determines if the input is a request for a next entry. In at least one embodiment, the input for a request for a next feed can be a swipe right. In other embodiments, the input for a request for a next feed can be a wave of a hand towards the right. In yet other embodiments, the input for a request for a modified next feed can be activating a control button, as described above. In yet other embodiments, a modified next feed can be presented automatically after the operator interacts with the parameters. For example, if the operator adds a new active parameter, a modified next feed incorporating the new active parameter can be presented after a predetermined amount of time. At block 1234, if a request for a next feed is made, the next feed becomes a current feed and the method continues to block 1208 where the current feed is presented.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device configured to display at least one feed comprising a plurality of entries based upon selected parameters, the electronic device comprising:
a touch-sensitive display; and
a processor coupled to the touch-sensitive display, the processor configured to execute instructions stored on a non-transitory medium, the instructions including:
acquiring at least a portion of the at least one feed comprising a plurality of entries and each of the plurality of entries being associated with one or more parameters, wherein the at least one feed comprises a current feed;
determining the current feed based on at least one active parameter;
presenting the current feed and the at least one active parameter;
determining that a request for a second feed is requested based on an input received at the electronic device; and
generating the second feed based on the input from an operator and one or more preferences, which are determined based on operator interaction with the electronic device.

2. The electronic device as recited in claim 1, wherein the touch-sensitive display comprises one of a capacitance-sensitive display, a pressure-sensitive display, or a resistive-sensitive display.

3. The electronic device as recited in claim 1, wherein the at least one active parameter corresponding to the current feed are configured to be bookmarked.

4. The electronic device as recited in claim 1, wherein the instructions further comprise displaying a parameter bar including the at least one active parameter, wherein at least one entry parameter corresponding to a currently presented entry is configured to be added to the parameter bar and incorporated as an active parameter.

5. The electronic device as recited in claim 1, wherein the instructions further comprise creating a merged parameter based upon two or more active parameters.

6. The electronic device as recited in claim 1, wherein the instructions further comprise removing at least one of the active parameters based upon a tree structure thereof or a folder structure thereof.

7. The electronic device as recited in claim 1, wherein the instructions further comprise:
accessing attributes of the plurality of entries;
adjusting interest in the plurality of entries based on the attributes and the at least one active parameter, wherein the attributes comprise at least one of likes, comments, time spent, and at least one entry parameter.

8. The electronic device as recited in claim 1, wherein the plurality of entries comprises at least one of a text, a picture, or an illustration.

9. The electronic device as recited in claim 1, wherein the second feed is based on at least one of the attributes of the plurality of entries, the one or more preferences, and the at least one active parameter.

10. The electronic device as recited in claim 1, wherein the instructions further comprise:
automatically moving to a next entry in a feed upon lapse of a predetermined amount of time or upon receipt of a vertical scroll command.

11. A method for manipulating and presenting at least one feed comprising a plurality of entries, the method comprising:
acquiring, at an electronic device, at least a portion of the at least one feed and the at least one feed being associated with one or more parameters, wherein the feed comprises a current feed;
determining, at the electronic device, the current feed based on at least one active parameter;
presenting, at the electronic device, the current feed and the at least one active parameter;
determining, at the electronic device, that a request for a modified next feed is requested based on an input received at the electronic device; and
generating, at the electronic device, the modified next feed based on the input from an operator and one or more preferences, which are determined based on operator interaction with the electronic device.

12. The method of claim 11, wherein the input comprises a swipe right to present the modified next feed and a swipe left to present a previous feed.

13. The method of claim 11, further comprising displaying a parameter bar including the at least one active parameter, wherein at least one entry parameter corresponding to a currently presented entry is configured to be added to the parameter bar and incorporated as an active parameter.

14. The method of claim 11, further comprising removing at least one of the active parameters based upon a tree structure thereof or a folder structure thereof.

15. The method of claim 11, further comprising creating a merged parameter based upon two or more active parameters.

16. The method of claim 11, further comprising:
accessing, at the electronic device, attributes of the plurality of entries;
adjusting, at the electronic device, a preference of the plurality of entries based on the attributes and the at least one active parameter, wherein the attributes comprise at least one of likes, comments, time spent, and at least one entry parameter.

17. The method of claim 11, wherein the plurality of entries comprises at least one of a text, a picture, or an illustration.

18. The method of claim 11, wherein the modified next feed is based on at least one of attributes of the plurality of entries, the one or more preferences, and the at least one active parameter.

19. The method of claim 11, wherein the at least one active parameter corresponding to the current feed are configured to be bookmarked.

20. The method of claim 11, wherein the one or more parameters have a relationship, wherein the relationship is at least one of a tree structure, a folder structure, a correlated structure, or a combination thereof.
